(19) United States
(12) Patent Application Publication
(10) Pub. No.: US 2025/0076201 A1
(43) Pub. Date: Mar. 6, 2025

(54) Multispectral In-Vivo Imaging Probe Device for Enhanced Tissue Visualization

(71) Applicant: CytoVeris Inc., Farmington, CT (US)

(72) Inventors: Alexandre Dumont, Windsor, CT (US); Noel Daignault, Burlington, CT (US); David Fournier, Northborough, MA (US)

(21) Appl. No.: 18/823,616

(22) Filed: Sep. 3, 2024

Related U.S. Application Data
(60) Provisional application No. 63/536,353, filed on Sep. 1, 2023.

(51) Int. Cl. G01N 21/64

(52) U.S. Cl. CPC G01N 21/6456; G01N 2021/6419; G01N 2201/0627; G01N 2201/1296; G01N 2223/401

(57) ABSTRACT

A system and method for analyzing a tissue is provided. The system includes an excitation light unit, a probe, a photodetector, and a system controller. The excitation light unit produces excitation lights. The probe has a flexible cable and a probe head. The flexible cable includes a plurality of light source optical fibers and a light receiving conveyance structure. The probe head receives the excitation lights and produces a distribution of incident light. The photodetector detects the autofluorescence emission, or the diffuse reflectance signal, or both from the tissue and produces signals representative thereof. The photodetector is in communication with the light receiving conveyance structure. Instructions when executed cause the system controller to control the excitation light unit, receive and process the signals from the photodetector, and produce an image representative of the signals produced by the excitation light application.

The present application claims priority to U.S. Patent Appln. No. 63/536,353 filed Sep. 1, 2023, which is hereby incorporated by reference in its entirety.

### BACKGROUND OF THE INVENTION

### 1. Technical Area

The present disclosure relates to devices and methods for in-vivo tissue analysis in general, and devices and methods for detecting diseased tissue in an intraoperative procedure in particular. In particular, the invention relates to the design and implementation of an imaging probe apparatus that provides for the imaging of biological tissue areas, from inside a patient, that are free from specular highlights, uniform in illumination and mitigates the effects of body fluid in the area of surgical intervention.

### 2. Background Information

Fluorescence imaging of biological tissue has become an established analytical approach for many studies of cells, tissue structure and disease, particularly in fluorescence microscopy applications, and can help visualize biological processes taking place in a living organism.

For many decades the reference method for the diagnosis of cancer has been histopathological examination of tissues using conventional microscopy. This process is known as surgical pathology. In surgical pathology, tissues can be produced from surgical procedures (tumor resection), diagnostic biopsies or autopsies. These tissues are subsequently subjected to a process that includes dissection, fixation, and cutting of tissue into precisely thin slices which are stained for contrast and mounted onto glass slides. The slides are examined by a pathologist under a microscope, and their interpretations of the tissue results in the pathology “read” of the tissue.

Advanced optical and electromagnetic (“EM”) imaging approaches have been reported for the determination of tumor margin: These include the use of exogenous contrast-based fluorescence imaging [1, 2], near infrared spectroscopy [3], mass spectroscopy [4], terahertz reflectivity [5], Raman spectroscopy [6-12], hyperspectral imaging [13], autofluorescence life-time imaging [14], and the like.

Of these, techniques that do not require any exogenous dye or contrast agents are particularly appealing in an in-vivo setting. Optical spectroscopy, in particular, offers significant advantages to patients by avoiding potential toxicological issues, Food and Drug Administration (FDA) approval of the contrast agents as drugs, the cost of the contrast agents and increased surgical time associated with administering imaging agents.

The endogenous fluorescence signatures offer useful information that can be mapped to the functional, metabolic and morphological attributes of a biological specimen, and have therefore been utilized for diagnostic purposes. Biomolecular changes occurring in the cell and tissue state during pathological processes and disease progression result in alterations of the amount and distribution of endogenous fluorophores and form the basis for classification. Tissue autofluorescence (AF) has been proposed to detect various malignancies including cancer by measuring either differential intensity or lifetimes of the intrinsic fluorophores. Biomolecules such as tryptophan, collagen, elastin, nicotinamide adenine dinucleotide (NADH), flavin adenine dinucleotide (FAD), porphyrins, etc. present in tissue provide discernible and repeatable AF spectral patterns. While tissue AF has been proposed for cancer detection, there are three major limitations for conventional AF-based diagnosis approaches. First, traditional AF assays typically use a single excitation wavelength which obviously does not excite all the intrinsic fluorophores present in the tissue. Consequently, traditional AF does not effectively utilize the comprehensive and rich biochemical information embedded in the tissue matrix both from cells and the extracellular matrix. Second, most of the applications involving AF use a fiber probe with single-point measurement capability and are inherently slow. Third, most of the AF approaches involve simpler data analysis such as calculating redox ratio or oxygenation index ratio, and do not utilize the rich morphological information.

U.S. Patent Publication No. 2023/0366821 [15], commonly assigned herewith and hereby incorporated by reference in its entirety, discloses a multi-spectral autofluorescence imager referred to as the “Aurora” imaging system. The imager produces multispectral imaging by selectively acquiring AF signals from important biomolecules (e.g., collagen, tryptophan, nicotinamide adenine dinucleotide (NADH) and flavin adenine dinucleotide (FAD)) using multiple excitation and emission filters. Embodiments of that system use advanced machine learning and AI algorithms on a multispectral dataset to fully exploit the fluorescence information content. This rapid and label-free approach, which offers cost-effectiveness and case-of-use, has the potential to democratize this technology in surgical and pathological settings.

It would be beneficial to provide a system and/or probe that can be used to produce multispectral images of in-vivo tissue from a patient, and one that provides imaging capability in a surgical cavity to assess for positive margins on tissue intended for removal by the surgical team (resected tissue), and/or residual cancer in the cavity.

### SUMMARY

According to an aspect of the present disclosure, a system for analyzing a tissue is provided that includes an excitation light unit, a probe, at least one photodetector, and a system controller. The excitation light unit is configured to selectively produce a plurality of excitation lights. Each excitation light is centered on a wavelength distinct from the centered wavelength of the other excitation lights. At least one of the excitation light centered wavelengths is configured to produce an autofluorescence emission from one or more biomolecules of interest present within the tissue, and a diffuse reflectance signal from the tissue. The probe has a flexible cable and a probe head attached to a distal end of the flexible cable. The flexible cable includes a plurality of light source optical fibers in communication with the excitation light unit to receive the plurality of excitation lights, and a light receiving conveyance structure configured to receive the autofluorescence emission, or the diffuse reflectance signal, or both. The probe head is configured to receive the plurality of excitation lights from the plurality of light source optical fibers and produce a distribution of incident light oriented to exit a probe head exit aperture for application to the tissue. The at least one photodetector is configured to detect the autofluorescence emission, or the diffuse reflectance signal, or both from the tissue as a result of the respective incident excitation light, and produce signals representative of the detected autofluorescence emission, or the detected diffuse reflectance signal, or both. The at least one photodetector is in communication with the light receiving conveyance structure to receive the autofluorescence emission, or the diffuse reflectance signal, or both. The system controller is in communication with the excitation light unit, the at least one photodetector, and a non-transitory memory storing instructions. The instructions when executed cause the system controller to: control the excitation light unit to sequentially produce the plurality of excitation lights; receive and process the signals from the at least one photodetector for each sequential application of the plurality of excitation lights, and produce an image representative of the signals produced by each sequential application of the plurality of excitation lights; and analyze the tissue using a plurality of the images to identify the presence of diseased tissue within the tissue.

In any of the aspects or embodiments described above and herein, the excitation light unit may include a plurality of excitation light sources, and each excitation light source may be configured to produce one of the excitation lights centered on a wavelength distinct from the respective centered wavelength of the other respective excitation lights.

In any of the aspects or embodiments described above and herein, the plurality of light source optical fibers and the light receiving conveyance structure may be concentrically arranged.

In any of the aspects or embodiments described above and herein, the plurality of light source optical fibers may be disposed in a ring arrangement radially outside of the light receiving conveyance structure.

In any of the aspects or embodiments described above and herein, the light receiving conveyance structure may include a plurality of optical fibers.

In any of the aspects or embodiments described above and herein, the light receiving conveyance structure may include a relay lens.

In any of the aspects or embodiments described above and herein, the probe head may include at least one Lambertian surface disposed to reflect the plurality of excitation lights from the plurality of light source optical fibers in a manner that produces the distribution of incident light oriented to exit the probe head through the probe head exit aperture for application to the tissue.

In any of the aspects or embodiments described above and herein, the distribution of incident light oriented to exit the probe head through the probe head exit aperture for application to the tissue may be substantially uniform.

In any of the aspects or embodiments described above and herein, the distribution of incident light oriented to exit the probe head through the probe head exit aperture for application to the tissue may be substantially uniform in angular and spatial orientation.

In any of the aspects or embodiments described above and herein, the distribution of incident light oriented to exit the probe head through the probe head exit aperture for application to the tissue may be randomized.

In any of the aspects or embodiments described above and herein, the probe head may include an inner diffuser structure and an outer diffuser structure, both centered on a probe head central axis.

In any of the aspects or embodiments described above and herein, the at least one Lambertian surface may include an inner diffuser Lambertian surface disposed relative to the plurality of light source optical fibers such that light exiting the plurality of light source optical fibers impinges upon the inner diffuser Lambertian surface for reflection within the probe head.

In any of the aspects or embodiments described above and herein, the at least one Lambertian surface may include an outer diffuser Lambertian surface disposed radially outside of the inner diffuser Lambertian surface.

In any of the aspects or embodiments described above and herein, the probe head may be configured such that the distribution of incident light for application to the tissue exits the probe head exit aperture in a generally axial direction.

In any of the aspects or embodiments described above and herein, the probe head may include an interior cavity, and the at least one Lambertian surface may define the interior cavity.

In any of the aspects or embodiments described above and herein, the probe head may be configured such that the distribution of incident light for application to the tissue exits the probe head exit aperture in a direction generally perpendicular to a central axis of the probe head.

In any of the aspects or embodiments described above and herein, the probe head exit aperture may be disposed parallel to the central axis of the probe head.

In any of the aspects or embodiments described above and herein, the probe head may include an imaging window engaged with the probe head exit aperture.

In any of the aspects or embodiments described above and herein, the probe head may include a prism configured to receive the autofluorescence emission, or the diffuse reflectance signal, or both from the tissue.

According to an aspect of the present disclosure, a method of analyzing a tissue is provided that includes: producing a plurality of excitation lights, each excitation light centered on a wavelength distinct from the centered wavelength of the other excitation lights, wherein at least one of the excitation light centered wavelengths is configured to produce autofluorescence emissions from one or more biomolecules of interest, and a diffuse reflectance signals from the tissue; using at least one Lambertian surface to randomize the plurality of excitation lights into a distribution of incident light that is substantially uniform in angular and spatial orientation and interrogating the tissue with the distribution of incident light; using at least one photodetector to detect the autofluorescence emissions, or the diffuse reflectance signals, or both from the tissue, and to produce photodetector signals representative of the detected autofluorescence emissions, or the detected diffuse reflectance signals, or both; processing the photodetector signals for each application of the distribution of incident light, including producing an image representative of the photodetector signals produced by each application of the distribution of incident light; and analyzing the tissue using each image to identify the presence of diseased tissue within the tissue.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

FIG. 1 is a diagrammatic illustration of a present disclosure system embodiment.

FIG. 2 is a diagrammatic illustration of a present disclosure system embodiment.

FIG. 2A is a diagrammatic illustration of a present disclosure system embodiment.

FIG. 3 is a diagrammatic illustration of an imaging probe embodiment.

FIG. 3A is a diagrammatic partial illustration of the imaging probe embodiment shown in FIG. 5.

FIG. 4 is a diagrammatic illustration of an imaging probe embodiment.

FIG. 5 is a histogram of incidence angle of light onto the tissue surface.

FIG. 6 is a plot of the irradiance profile over the imaging area.

FIG. 7 is a diagrammatic illustration of an imaging probe embodiment.

FIG. 7A is a diagrammatic exploded view of the imaging probe embodiment shown in FIG. 7.

### DISCLOSURE OF THE INVENTION

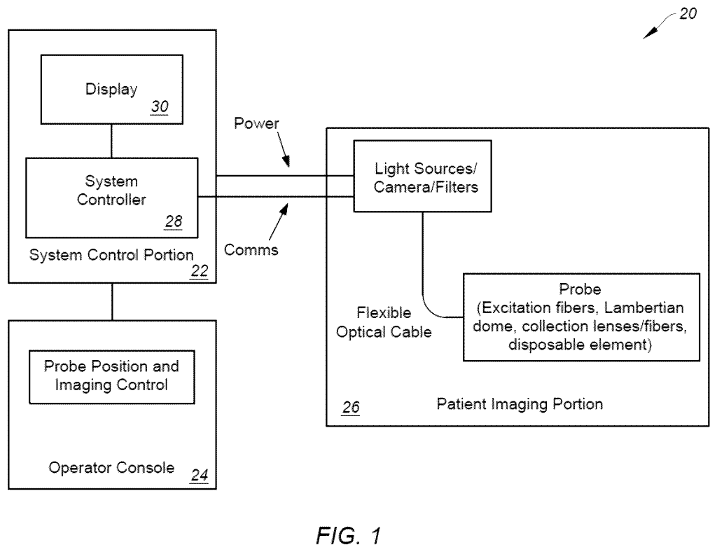

An exemplary embodiment of a present disclosure system 20 is diagrammatically illustrated in FIG. 1. The system 20 includes a system control portion 22, an operator console 24, and a patient imaging portion 26. The system control portion 22 may include a system controller 28 (detailed herein) and a display device 30; e.g., a monitor configured to display tissue images and/or other relevant information. The operator console 24 may include input apparatus for controlling aspects of the system 20; e.g., for controlling movement and/or operation of a probe. The present disclosure is not limited to any particular type of system control devices. The patient imaging portion 26 may include optical imaging hardware and control devices therefore (as will be detailed herein) and a probe (as will be detailed herein). The present disclosure is not limited to the embodiment diagrammatically shown in FIG. 1. For example, in alternative embodiments, the system control portion 22 and the operator console 24 may be combined into a single unit. As another example, some or all of the optical imaging hardware and control devices diagrammatically shown as a part of the patient imaging portion 26 may be included in the system control portion 22.

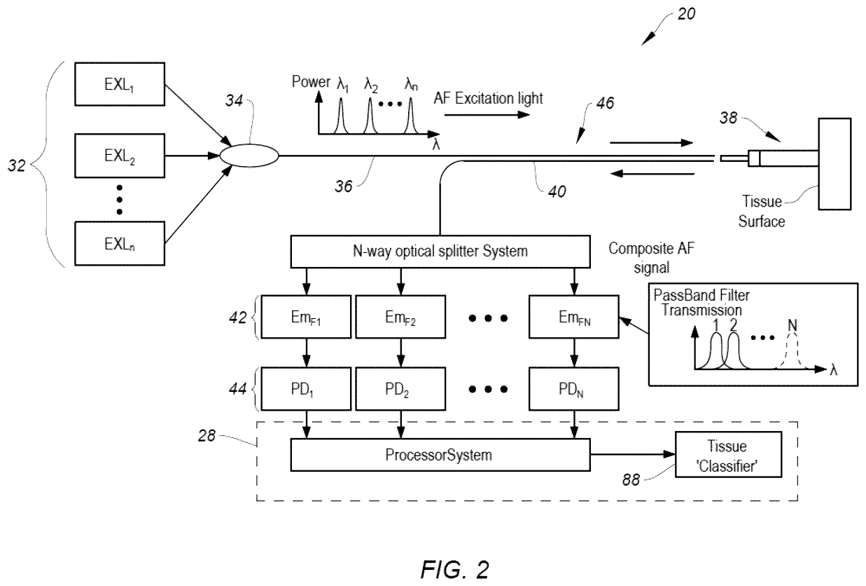

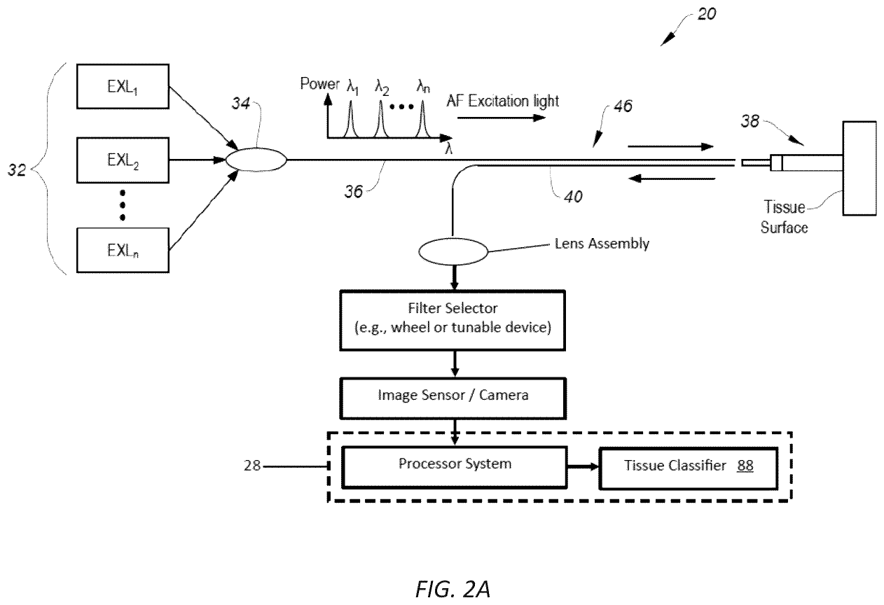

FIG. 2 diagrammatically illustrates a present disclosure system 20 embodiment that includes an excitation light unit 32, an optical switch 34, one or more first optical fibers 36, a probe 38, one or more second optical fibers 40, an emission light filter assembly 42, a photodetector arrangement 44, and a system controller 28. These system elements may be arranged as shown in FIG. 1 but are not limited to that exemplary arrangement.

The excitation light unit 32 is configured to produce excitation light centered at a plurality of different wavelengths. As will be detailed below, the term “excitation light unit” as used herein refers to a light source configured to produce excitation light that causes AF emissions and produce reflectance signals. Examples of an acceptable excitation light unit 32 include lasers and/or light emitting diodes (LEDs) each centered at a different wavelength, or a tunable excitation light source configured to selectively produce light centered at respective different wavelengths, or a source of white light (e.g., flash lamps) that may be selectively filtered to produce the aforesaid excitation light centered at respective different wavelengths. In those embodiments that include a tunable excitation light source, the tunable excitation light source may be operated to sequentially produce each of the respective excitation wavelengths. The present disclosure is not limited to any particular type of excitation light unit 32, provided the produced light can be conveyed into a light receiving conveyance structure (e.g., optical fibers) for delivery to a probe 38.

In the exemplary embodiment shown in FIG. 2, the excitation light unit 32 includes a plurality of independent excitation light sources (e.g., EXL₁ . . . EXLₙ, where “n” is an integer greater than one), each operable to produce an excitation light centered at a particular wavelength and each centered on an excitation wavelength different from the others. Each of the plurality of independent excitation light sources produces excitation light centered on a different wavelength.

The respective excitation wavelengths are chosen based on either native tissue fluorophores that may be present within diseased tissue and the significance of those fluorophores relative to diseased tissue or based on the reflectance characteristics of certain tissue types and the significance of those tissue types relative to diseased tissue, or both. In other words, excitation wavelengths may be chosen that are known to produce identifiable AF emissions from native fluorophores having emission characteristics (e.g., intensity, density of signal within a given area, etc.) that provide information regarding the presence of diseased tissue (e.g., cancerous tissue) and/or to produce identifiable reflectance emissions from the tissue having characteristics that provide information regarding the presence of diseased tissue.

The wavelengths produced by the excitation light unit 32 are typically chosen based on the photometric properties associated with one or more biomolecules of interest. Excitation light incident to a biomolecule that acts as a fluorophore will cause the fluorophore to emit fluorescent light at a wavelength longer than the wavelength of the excitation light; i.e., via AF. Tissue may naturally include certain fluorophores such as tryptophan, collagen, elastin, nicotinamide adenine dinucleotide (NADH), flavin adenine dinucleotide (FAD), porphyrins, and the like. Biomolecular changes occurring in the cell and tissue state during pathological processes and as a result of disease progression often result in alterations of the amount and distribution of these endogenous fluorophores. Hence, diseased tissues such as cancerous tissue, due to the marked difference in cell-cycle and metabolic activity can exhibit distinct intrinsic tissue AF, or in other words an “AF signature” that is identifiable.

Embodiments of the present disclosure may utilize these AF characteristics/signatures to identify regions of diseased tissue such as cancerous tissue. Different types of diseased tissue (e.g., different types of cancerous tissue) and diseases tissue of different organs for instance breast and liver cancers may have different biomolecules/biochemicals associated therewith and the present disclosure is not therefore limited to any particular biomolecule or any particular cancer type. Excitation wavelengths are also chosen that cause detectable light reflectance from tissue of interest. The detectable light reflectance is a function of light absorption of the tissue and/or light scattering associated with the tissue (this may be collectively referred to as diffuse reflectance). Certain tissue types or permutations thereof have differing and detectable light reflectance characteristics (“signatures”) at certain wavelengths. Significantly, these reflectance characteristics can provide information beyond intensity; e.g., information relating to cellular or microcellular structure such as cell nucleus and extracellular components. The morphology of a healthy tissue cell may be different from that of an abnormal or diseased tissue cell. Hence, the ability to gather cellular or microstructural morphological information (sometimes referred to as “texture”) provides another tool for determining tissue types and the state and characteristics of such tissue. The excitation light source may be configured to produce light at wavelengths in the ultraviolet (UV) region (e.g., 100-400 nm) and in some applications may include light in the visible region (e.g., 400-700 nm), and or the near- and shortwave-infrared regions (NIR: 700-1000 nm, SWIR: 1000-2500 nm). The excitation lights are chosen based on the absorption and fluorescence characteristics of the biomolecules of interest.

The excitation light unit 32 is in direct or indirect communication with the system controller 28. In the example system 20 embodiment shown in FIG. 2, the independent excitation light sources (e.g., EXL₁ . . . EXLₙ) are UV LEDs. The LEDs may be in communication with an LED driver that may be independent of the system controller 28 or the functionality of the LED driver may be incorporated into the system controller 28. As stated above, the present disclosure is not limited to the excitation light unit 32 example shown in FIG. 2.

The excitation light unit 32 is in communication with the probe 38. In some embodiments, the excitation light unit 32 may be in photometric communication with the probe 38 via a flexible optical cable 46 that includes a plurality of optical fibers configured to convey light emitted from the excitation light unit 32; e.g., first optical fibers 36. The present disclosure is not limited to any particular light receiving conveyance structure (e.g., second optical fibers 40) within the flexible optical cable 46. The probe 38 and structure operable to convey light to and from the probe 38 is described in greater detail herein.

The system 20 embodiment example shown in FIG. 2 includes an optical switch 34. Embodiments of the present disclosure system 20 may not include an optical switch 34.

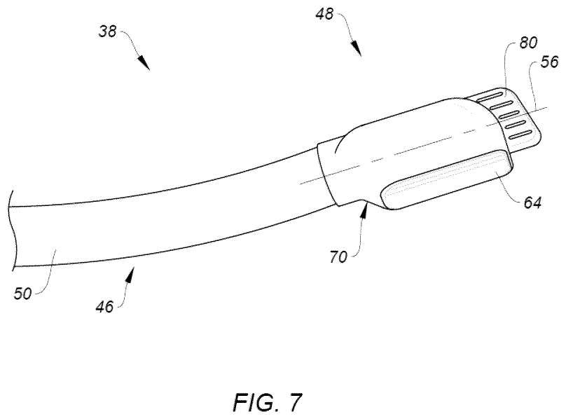

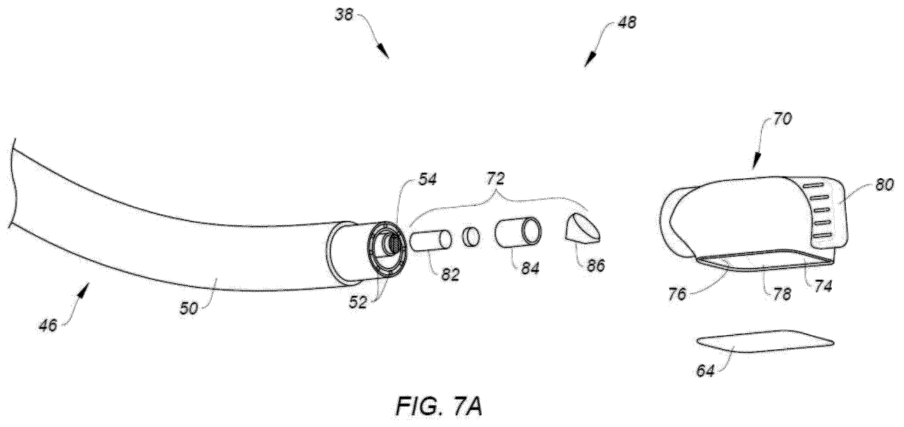

The light emitted by the tissue due to AF and that reflected from the tissue is conveyed to a photodetector; e.g., a photodetector PD₁, PD₂, . . . PD_{N} within the photodetector arrangement 44. The light receiving conveyance structure may include a relay lens assembly (e.g., see FIG. 7A), as generally found in standard endoscope designs, or a flexible coherent optical imaging bundle of optical fibers, or the like. The present disclosure is not limited to any particular type of structure for conveying light to the photodetector; e.g., photodetector arrangement 44. In a preferred embodiment, a flexible optical fiber bundle is used. Examples of present disclosure probe 38 embodiments and light receiving conveyance structure associated therewith are provided herein.

A variety of different photodetector types configured to sense light emitted by the tissue due to AF and light reflected from the tissue and produce signals representative thereof may be used within the present disclosure system 20. Non-limiting examples of an acceptable photodetector include those that convert light energy into an electrical signal such as photodiodes, avalanche photodiodes, a CCD array, an ICCD, a CMOS, or the like. In general, the photodetector may take the form of a image sensor, or camera. As will be described below, the photodetector(s) are configured to detect AF emissions from the interrogated tissue and/or diffuse reflectance from the interrogated tissue and produce signals representative of the detected light and communicate the signals to the system controller 28. The system 20 embodiment example shown in FIG. 2 includes a photodetector arrangement 44 includes a plurality of photodetectors (e.g., PD₁, PD₂, . . . PD_{N}).

The system controller 28 is in communication with system components including but not limited to the excitation light unit 32 and the photodetectors (e.g., PD₁, PD₂, . . . PD_{N}). In some system embodiments, the system controller 28 may also be in communication with one or more of: an LED driver, a filter controller, a tunable optical filtering device, an optical switch, an optical splitter, and the like as will be described below. The system controller 28 may be in communication with these components to control and/or receive signals therefrom to perform the functions described herein. The system controller 28 may include any type of computing device, computational circuit, processor(s), CPU, computer, or the like capable of executing a series of instructions that are stored in memory. The instructions may include an operating system, and/or executable software modules such as program files, system data, buffers, drivers, utilities, and the like. The executable instructions may apply to any functionality described herein to enable the system controller 28 to accomplish the same algorithmically and/or coordination of system components. The system controller 28 includes or is in communication with one or more memory devices. The present disclosure is not limited to any particular type of memory device, and the memory device may store instructions and/or data in a non-transitory manner. Examples of memory devices that may be used include read-only memory, random access memory, volatile memory, non-volatile memory, static memory, dynamic memory, flash memory, cache memory, and/or any device that stores digital information. The system controller 28 may include, or may be in communication with, an input device that enables a user to enter data and/or instructions, and may include, or be in communication with, an output device configured, for example to display information (e.g., a visual display or a printer), or to transfer data, etc. Communications between the system controller 28 and other system components may be via a hardwire connection or via a wireless connection.

Embodiments of the present disclosure may include optical filtering elements configured to filter excitation light, or optical filtering elements configured to filter emitted light (including reflected light), or both. Each optical filtering element is configured to pass a defined bandpass of wavelengths associated with an excitation light source or emitted/reflected light (e.g., fluorescence or reflectance), and may take the form of a bandpass filter. In regard to filtering excitation light, the system 20 may include an independent filtering element associated with each independent excitation light source or may include a plurality of filtering elements disposed in a movable form (e.g., a wheel or a linear array configuration) or may include a single filtering element (e.g., a tunable device) that is operable to filter excitation light at a plurality of different wavelengths or each excitation light source may be configured to include a filtering element, or the like. In regard to filtering emitted light, the system 20 may include a plurality of independent filtering elements each associated with a different bandwidth or may include a plurality of filtering elements disposed in a movable form or may include a single filtering element that is operable to filter emitted/reflected light at a plurality of different wavelengths or the like. The bandwidth of the emitted/reflected light filters are typically chosen based on the photometric properties associated with one or more biomolecules of interest. Certain biomolecules may have multiple emission or reflectance peaks. The bandwidth of the emitted/reflected light filters are typically chosen to allow only emitted/reflected light from a limited portion of the biomolecule emission/reflectance response; i.e., a portion of interest that facilitates the analysis described herein.

The system 20 embodiment example shown in FIG. 2 includes an emission light filter assembly 42 having a plurality of narrow bandpass filters (e.g., Em_{F1}, Em_{F2}, . . . Em_{FN}, where “N” is an integer greater than one). Each narrow bandpass filter may be centered at a wavelength in the UV/visible/NIR/SWIR region, which wavelength is different from those of the other narrow bandpass filters. As stated herein, the photodetector arrangement 44 example shown in FIG. 2 includes a plurality of photodetectors (e.g., PD₁, PD₂, . . . PD_{N}). Each photodetector may be chosen to provide optimal performance at the wavelength/spectral range of light passed by the respective narrow bandpass filter, and at low intensity levels. In some embodiments, the light intensity monitored at each photodetector can be integrated for a time duration (“T”) to increase the effective signal to noise ratio (“SNR”). Each respective photodetector produces signals representative of the filtered emitted light, and those signals are communicated to the system controller 28.

FIG. 2A diagrammatically illustrates an alternative present disclosure system 20 embodiment that includes an excitation light unit 32, an optical switch 34, one or more first optical fibers 36, a probe 38, one or more second optical fibers 40, a filter selector, an image sensor/camera, and a system controller 28. The filter selector may include a plurality of filtering elements disposed in a movable form (e.g., a wheel or a linear array configuration) or may include a single filtering element (e.g., a tunable device) that is operable to filter AF emitted/reflected light at a plurality of different wavelengths. The image sensor may be any type of device operable to convert light energy into an electrical signal for further processing.

The probe 38 of the present disclosure system 20 is configured to substantially improve the consistency and the quality of in-vivo tissue imaging. Embodiments of the present disclosure probe 38 utilize surfaces configured to produce Lambertian reflection of light incident to the respective surface. These surfaces are referred to herein as “Lambertian surfaces”. The Lambertian surfaces are arranged within the probe 38 to produce a distribution of excitation light that is substantially more uniform in both angular orientation and spatial orientation than a distribution that is associated with, for example, point light sources. The present disclosure probe 38 may be described as producing a “randomized” distribution of the excitation light (e.g., substantially uniform in angular and spatial orientation) at an imaging window that configured to be disposed contiguous with or closely adjacent to the in-vivo tissue to be imaged. The substantially improved uniformity (e.g., in angular and spatial orientation) of the excitation light is understood to substantially improve the resultant tissue imaging; e.g., substantially all of the tissue being imaged is subject to substantially uniform incident light thereby leading to improved imaging.

The ability of the present disclosure probe 38 to deliver light in a substantially uniform manner (both angularly and spatially) to the tissue image area increases the imaging consistency across different tissue types, as well from instrument to instrument. In this manner, the analysis of the imaging is understood to be greatly enhanced.

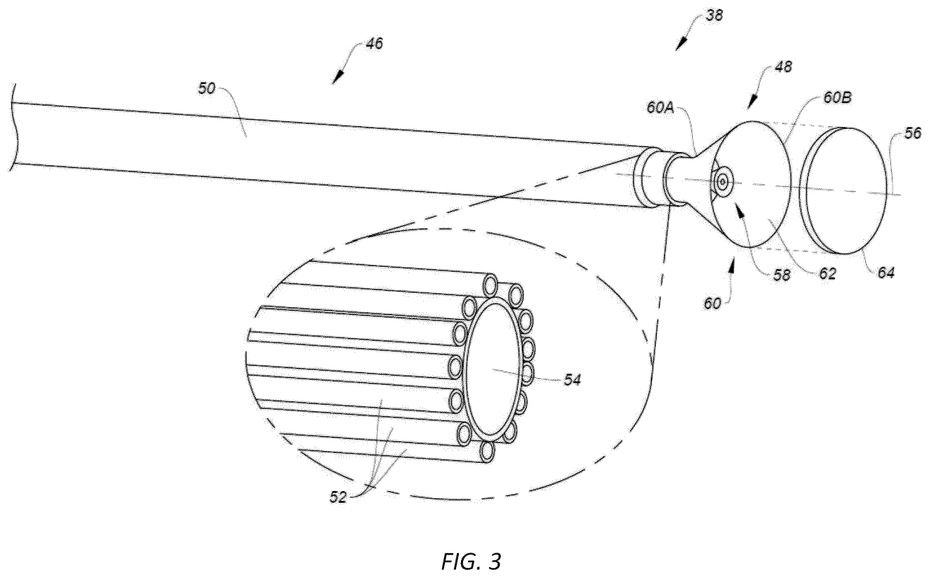

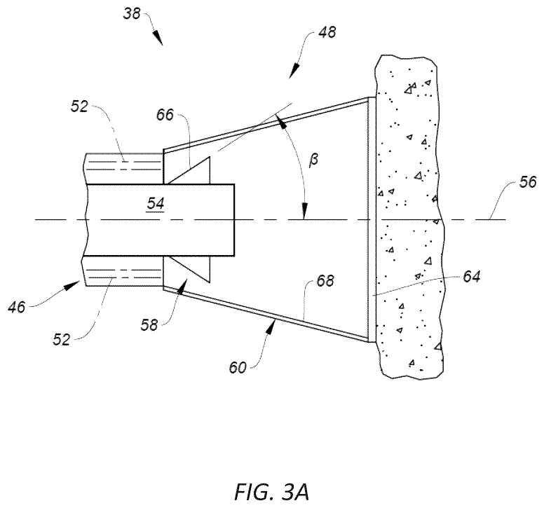

A non-limiting example of a present disclosure probe 38 embodiment is diagrammatically shown in FIGS. 3 and 3A. In this example, the flexible optical cable 46 is configured as an endoscopic cable with a probe head 48 disposed at a distal end of the optical cable 46. Referring to FIG. 3, the optical cable 46 includes an outer cladding 50, a plurality of light source optical fibers 52 (i.e., functioning as first optical fibers 36), and a light receiving conveyance structure 54. In the embodiment diagrammatically shown, the light receiving conveyance structure 54 is shown as having a circular cross-sectional geometry and the plurality of light source optical fibers 52 are disposed around the outer circumference of the light receiving conveyance structure 54; i.e., a “ring” of light source optical fibers 52. In some embodiments, a light blocking cladding (not shown) may be disposed around the outer circumference of the light receiving conveyance structure 54, radially inside of the plurality of light source optical fibers 52 to avoid light transfer between the light receiving conveyance structure 54 and the plurality of light source optical fibers 52. As described herein, the light receiving conveyance structure 54 (for conveying light to the photodetector) may take the form of a relay lens assembly, or a flexible coherent optical imaging bundle of optical fibers, or the like.

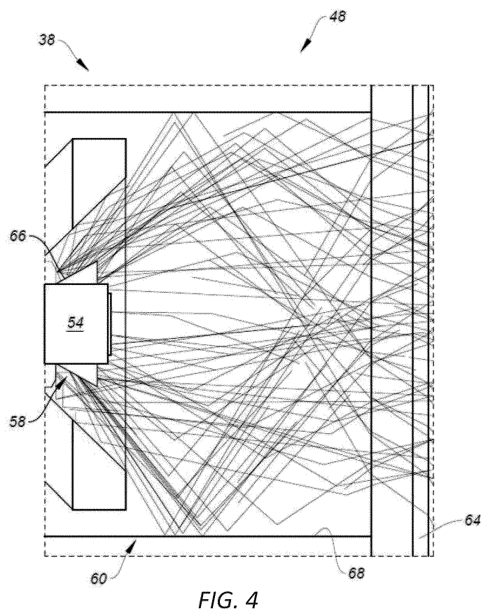

The probe head 48 diagrammatically shown with the probe 38 embodiment of FIGS. 3 and 3A is configured to produce excitation light and receive AF light emitted by the tissue and/or light reflected from the tissue that is traveling generally along an axially extending central axis 56 of the probe head 48 when exiting or entering the probe head 48. To facilitate the description herein, the AF light emitted by the tissue and/or light reflected from the tissue may be referred to collectively as “tissue response light”. The probe head 48 includes an inner diffuser structure 58 and an outer diffuser structure 60, both centered on the probe head central axis 56. The outer diffuser structure 60 extends axially from a cable end 60A to a distal end 60B. In the exemplary embodiment shown, the outer diffuser structure 60 includes a conical portion that increases in diameter in an axial direction (along the probe head central axis 56) from the cable end 60A to the distal end 60B. The distal end 60B of the outer diffuser structure 60 defines a probe head exit aperture 62. In some embodiments, the probe head 48 may include an imaging window 64 that may be disposed at the distal end 60B of the outer diffuser structure 60; i.e., at the probe head exit aperture 62. Referring to FIG. 3A, the inner diffuser structure 58 includes a Lambertian surface 66 that is disposed at an angle beta (“β”) relative to the probe head central axis 56. The angle may be in a range of greater than zero degrees and less than ninety degrees (β>0° and B<) 90°. The Lambertian surface 66 of the inner diffuser structure 58 is disposed relative to the light source optical fibers 52 such that light exiting the light source optical fibers 52 will impinge upon the Lambertian surface 66 of the inner diffuser structure 58 and will be reflected within the probe head 48. The outer diffuser structure 60 includes an outer diffuser Lambertian surface 68. In the example shown in FIGS. 3 and 3A, the outer diffuser Lambertian surface 68 is a conical structure disposed at an angle relative to the probe head central axis 56; i.e., greater than zero degrees and less than ninety degrees. The present disclosure does not require the outer diffuser Lambertian surface 68 to be disposed at an angle (>0° and <) 90° relative to the probe head central axis 56. As will be detailed herein, in some embodiments at least a portion of an outer diffuser Lambertian surface 68 may be disposed parallel to the probe head central axis 56 (e.g., see FIG. 4) or other angle relative to the probe head central axis 56. In those embodiments that include an imaging window 64, the imaging window 64 is configured to allow the passage of excitation light through the imaging window 64 and thereafter incident to the tissue being imaged, and to allow the passage of AF emitted light and/or reflected light resulting from diffuse reflectance from the tissue to pass therethrough for collection by the light receiving conveyance structure 54.

During operation of the above-described probe 38 embodiment, the “ring” of light source optical fibers 52 conveys excitation light from the excitation light unit 32 through the flexible optical cable 46 and into the probe head 48. Light exits the light source optical fibers 52 and is reflected within the probe head 48 by the respective Lambertian surfaces 66, 68; e.g., first off of the inner diffuser Lambertian surface 66 and subsequently off of the outer diffuser Lambertian surface 68. The light reflections produce a distribution of excitation light, substantially uniform in both angular orientation and spatial orientation (i.e., “randomized”), that is incident to the tissue being imaged. In those embodiments that include an imaging window 64, the distribution of light passes through the imaging window 64 prior to being incident with the tissue; e.g., FIG. 4 diagrammatically illustrates a distribution of light disposed within a probe head 48 to convey how light may distribute within the probe head 48. In response to the incident excitation light, AF emitted light within the tissue and/or reflected light resulting from diffuse reflectance within the tissue is produced and is collected by the light receiving conveyance structure 54, which in turn conveys the collected light to the photodetector; e.g., PD₁, PD₂, . . . PD_{N} as shown in FIG. 2).

The present disclosure is not limited to the probe head 48 examples diagrammatically shown in FIGS. 3, 3A, and 4. The present disclosure contemplates any probe head 48 configuration that includes Lambertian surfaces that reflect the excitation light in a manner that creates a distribution of excitation light, substantially uniform in both angular orientation and spatial orientation, that is incident to the tissue being imaged. In addition, the present disclosure probe 38 is well-suited for use in an endoscopic application. In such an application, it may be desirable to have a probe head that has a small geometric configuration. In some embodiments, the present disclosure probe head 48 may be disposable in a non-deployed configuration that facilitates insertion of the probe head 48 endoscopically, and in a deployed configuration (larger than the non-deployed configuration) that facilitates the imaging process. Still further, the probe 38 is described above with a cable portion that includes a ring of light source optical fibers 52 concentric with a light receiving conveyance structure 54. The present disclosure is not limited to this concentric configuration. In alternative configurations, the light source optical fibers 52 and the light receiving conveyance structure 54 may be disposed in a side by side arrangement, or other nonconcentric arrangement, or the light source optical fibers 52 and the light receiving conveyance structure 54 may be disposed concentrically with the light receiving conveyance structure 54 disposed radially outside of the light source optical fibers 52.

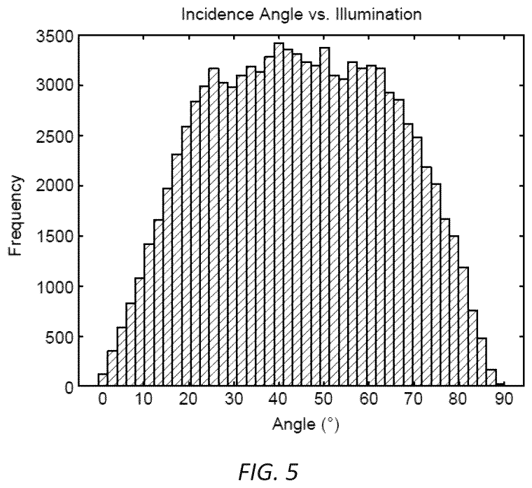

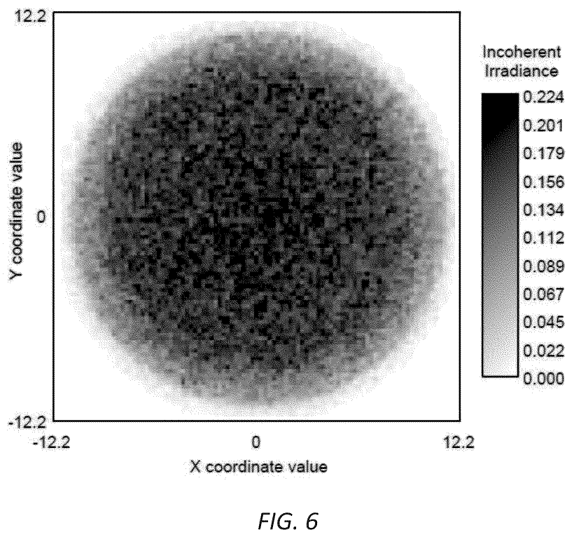

FIGS. 5 and 6 diagrammatically illustrate the substantially uniform distribution of excitation light that may be produced by embodiments of the present disclosure probe 38. FIG. 5 is a graph of excitation light incidence angle versus excitation light (i.e., illumination) frequency. FIG. 6 is a diagrammatic plot of an irradiance profile over an X-Y imaging area.

Another non-limiting example of a probe head 48 configuration is diagrammatically shown in FIGS. 7 and 7A. In the example shown in FIGS. 7 and 7A, the probe 38 may include a flexible optical cable 46 like that described herein with respect to FIGS. 5 and 5A; e.g., an optical cable configured for endoscopic use with a probe head 48 disposed at a distal end of the optical cable 48, wherein the optical cable 46 includes an outer cladding 50, a plurality of light source optical fibers 52, and a light receiving conveyance structure 54. Here again, the ring of light source optical fibers 52 may be disposed around the outer circumference of the light receiving conveyance structure 54, but the present disclosure is not limited to this exemplary configuration.

The probe head 48 diagrammatically shown in FIGS. 7 and 7A is configured to convey a distribution of excitation light and receive AF light emitted by the tissue and/or light reflected from the tissue (i.e., “tissue response light”) that is traveling in a direction that is generally perpendicular (e.g., +/−10 degrees) from the axially extending central axis 56 of the probe head 48 when exiting or entering the probe head 48.

The probe head 48 embodiment shown in FIGS. 7 and 7A includes a housing 70, optical components 72, and an imaging window 64. The housing 70 has an interior cavity 74 defined by a Lambertian surface 76 and a probe head exit aperture 78 disposed generally parallel to an axially extending central axis 56 of the housing 70. The probe head exit aperture 78 is configured to mate with the imaging window 64. In some embodiments, the housing interior cavity 74 may include a Porex® lined surface configured as a Lambertian surface. The interior cavity 74 is geometrically configured to produce a substantially uniform/randomized (e.g., in angular and spatial orientation) distribution of excitation light that exits the housing 70 through the imaging window 64. In some embodiments (e.g., like that shown in FIGS. 7 and 7A), the housing 70 may include a mechanical feature (e.g., a “robot grip 80”) disposed on the exterior of the housing 70. The mechanical feature is configured to allow a robot gripper to hold onto the probe head 48 and manipulate it to an area of interest to image the in-vivo tissue.

The optical components 72 may be configured to convey excitation light from the ring of light source optical fibers 52 to the Lambertian surface of the housing 70, and to convey the received AF light emitted by the tissue and/or light reflected from the tissue (i.e., “tissue response light”) to the light receiving conveyance structure 54, which in turn conveys the collected light to the photodetector. In the example probe head 48 configuration shown in the exploded view of FIG. 7A, the optical components 72 include a gradient-index (“GRIN”) objective 82, a reflector tube 84, and a prism 86. The GRIN objective 82 is configured to arrange the collected light for conveyance into the light receiving conveyance structure 54. The reflector tube 84 is configured to receive the GRIN objective 82 and functions to photometrically isolate the collected light conveying through the GRIN objective 82 from the excitation light reflecting within the housing interior cavity 74. The prism 86 is configured to reflect the collected light traversing in a first direction substantially perpendicular to the axially extending central axis 56 of the housing 70 to a second direction substantially parallel to the central axis 56 of the housing 70, thereby aligning the collected light with the light receiving conveyance structure 54.

During operation of the probe 38 embodiment diagrammatically shown in FIGS. 7 and 7A, the ring of light source optical fibers 52 conveys excitation light from the excitation light unit 32 through the flexible optical cable 46 and into the interior cavity 74 of the probe head housing 70. The light exits the light source optical fibers 52 and is reflected within the interior cavity 74 by the Lambertian surface(s) that define the probe head interior cavity 74. The light reflections produce a distribution of excitation light, substantially uniform in both angular orientation and spatial orientation (i.e., “randomized”), that exits the probe head interior cavity 74 through the imaging window 64. In response to the incident excitation light, AF emitted light and/or reflected light resulting from diffuse reflectance from the tissue is produced, passes through the imaging window 64, and is collected by the optical components; e.g., the prism 86. The collected light is subsequently conveyed to the light receiving conveyance structure 54, which in turn conveys the collected light to the photodetector.

The present disclosure is not limited to the exemplary probe head 48 configuration shown in FIGS. 7 and 7A. The present disclosure contemplates any probe head 48 configuration that includes Lambertian surfaces that reflect the excitation light in a manner that creates a distribution of excitation light (substantially uniform in both angular and spatial orientations), that is incident to the imaging window 64 and thereafter to the tissue being imaged. The probe head 48 configuration diagrammatically shown in FIGS. 7 and 7A is well-suited for use in an endoscopic application; e.g., the probe head 48 configuration may possess a low profile. In those embodiments having a robot grip 80, the robot grip 80 allows the probe head 48 to be manipulated (e.g., rotated) to facilitate the imaging process.

Advantages of this system 20 are understood to include materials and methods for providing illumination light impinging on an in-vivo tissue, that produce consistent measurements of tissue absorption and fluorescence properties.

The uniformity of illumination from the present disclosure probe 38 embodiments substantially reduces or eliminates specular highlights that are often present when prior art light illumination schemes are used. There are multiple presently available systems for making fluorescence images, as well direct images laparoscopically or within a robotic operating theatre. These presently available systems may use a ring (or a semi-ring) or even multiple point sources to illuminate the area of interest. The source illumination produced in these prior art devices is not sufficiently controlled to produce consistent measurements of direct illumination images.

Embodiments of the present disclosure may use the signals (i.e., image) representative of the emitted light (AF and/or reflectance) captured by the photodetector arrangement 44 (e.g., camera or plurality of photodetectors) for each excitation light wavelength to collectively provide a mosaic of information relating to the tissue. As described in U.S. Patent Publication No. 2023/0366821, incorporated by reference in its entirety herein, a variety of excitation and detection wavelengths can be used, and the system 20 is not limited to any pre-defined set of wavelengths.

The collective information provided by the aforesaid plurality of emitted/reflected light images produced by the present disclosure system 20, however, provides distinct information at different excitation wavelengths that can be used to identify biomolecule/tissue types with a desirable degree of specificity and sensitivity. In some embodiments, the system controller 28 (via stored instructions) may utilize a stored empirical database during the analysis of the tissue. A clinically significant number of stored AF and/or reflectance images of known tissue types (e.g., adipose, cancerous tissue, benign tissue, etc.) may be used to comparatively analyze the emitted light images (AF and/or reflectance) collected from the tissue at the various different excitation wavelengths. The aforesaid analysis may utilize one or more stored algorithms, and those algorithms may apply weighing factors, or corrective factors, or the like. In some embodiments, reflectance signals/images may be used directly in a classifier and/or to correct AF images.

In some embodiments, the stored instructions within the system controller 28 may include an artificial intelligence/machine learning (AI/ML) algorithm trained classifier 88 (e.g., see FIG. 2) that is “trained” using a clinically significant number of images of known tissue types (e.g., adipose, cancerous tissue, benign tissue, etc.) collected at the respective excitation wavelengths. The trained classifier 88 in turn may be used to evaluate the acquired light images (AF and/or reflectance) collected from the tissue at the various different excitation wavelengths to determine the presence or absence of biomolecule/tissue types indicative of diseased tissue (e.g., cancerous tissue). A dictionary learning, anomaly detector, convolutional neural network (CNN) or a random forest type classifier are examples algorithms that may be used. The present disclosure is not limited to these examples.

While the principles of the disclosure have been described above in connection with specific apparatuses and methods, it is to be clearly understood that this description is made only by way of example and not as limitation on the scope of the disclosure. Specific details are given in the above description to provide a thorough understanding of the embodiments. However, it is understood that the embodiments may be practiced without these specific details.

It is noted that the embodiments may be described as a process which is depicted as a flowchart, a flow diagram, a block diagram, etc. Although any one of these structures may describe the operations as a sequential process, many of the operations can be performed in parallel or concurrently. In addition, the order of the operations may be rearranged. A process may correspond to a method, a function, a procedure, a subroutine, a subprogram, etc.

The singular forms “a,” “an,” and “the” refer to one or more than one, unless the context clearly dictates otherwise. For example, the term “comprising a specimen” includes single or plural specimens and is considered equivalent to the phrase “comprising at least one specimen.” The term “or” refers to a single element of stated alternative elements or a combination of two or more elements unless the context clearly indicates otherwise. As used herein, “comprises” means “includes.” Thus, “comprising A or B,” means “including A or B, or A and B,” without excluding additional elements.

It is noted that various connections are set forth between elements in the present description and drawings (the contents of which are included in this disclosure by way of reference). It is noted that these connections are general and, unless specified otherwise, may be direct or indirect and that this specification is not intended to be limiting in this respect. Any reference to attached, fixed, connected or the like may include permanent, removable, temporary, partial, full and/or any other possible attachment option.

No element, component, or method step in the present disclosure is intended to be dedicated to the public regardless of whether the element, component, or method step is explicitly recited in the claims. No claim element herein is to be construed under the provisions of 35 U.S.C. 112 (f) unless the element is expressly recited using the phrase “means for.” As used herein, the terms “comprise”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various inventive aspects, concepts and features of the disclosures may be described and illustrated herein as embodied in combination in the exemplary embodiments, these various aspects, concepts, and features may be used in many alternative embodiments, cither individually or in various combinations and sub-combinations thereof. Unless expressly excluded herein all such combinations and sub-combinations are intended to be within the scope of the present application. Still further, while various alternative embodiments as to the various aspects, concepts, and features of the disclosures—such as alternative materials, structures, configurations, methods, devices, and components, and so on—may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present application even if such embodiments are not expressly disclosed herein. For example, in the exemplary embodiments described above within the Detailed Description portion of the present specification, elements may be described as individual units and shown as independent of one another to facilitate the description. In alternative embodiments, such elements may be configured as combined elements. It is further noted that various method or process steps for embodiments of the present disclosure are described herein. The description may present method and/or process steps as a particular sequence. However, to the extent that the method or process does not rely on the particular order of steps set forth herein, the method or process should not be limited to the particular sequence of steps described. As one of ordinary skill in the art would appreciate, other sequences of steps may be possible.

### REFERENCES

The following references are hereby incorporated by reference in their respective entireties:
1. Nguyen and Tsien, “Fluorescence-guided surgery with live molecular navigation—a new cutting edge”, Nat Rev Cancer, 13 (9), pp. 653-662, 2013.
2. Tummers, et al., “Real-time intraoperative detection of breast cancer using near-infrared fluorescence imaging and methylene blue”, Eur J Surg Oncol., 40 (7), 850-858, 2014.
3. Dahr et al., “A diffuse reflectance spectral imaging system for tumor margin assessment using custom annular photodiode arrays”, Biomedical Optics Express, 3, (12), 2012.
4. Hanel et al., “Mass spectroscopy-based interoperative tumor diagnostics”, Future Sci OA, 5 (3), 2019 March
5. Yaroslavsky. A, et al., “Delineating nonmelanoma skin cancer margins using terahertz and optical imaging”, J of Biomedical Photonics & Eng., 3 (1), 2017.
6. Pence I., Mahadevan-Jansen A., “Clinical instrumentation and applications of Raman spectroscopy”, Chem Soc Rev.; 45 (7): 1958-1979, 2016.
7. Talari, A. et al., “Raman Spectroscopy of Biological Tissues”, Applied Spectroscopy Reviews, 50:1, 46-111, 2015.
8. A. S. Haka, et al, “In vivo margin assessment during partial mastectomy breast surgery using Raman spectroscopy,” Cancer Res. 66 (6), 3317-3322 (2006).
9. J. Mo, et al., “High wavenumber Raman spectroscopy for in vivo detection of cervical dysplasia,” Anal. Chem. 81 (21), 8908-8915 (2009).
10. K. Lin, et al., “Optical diagnosis of laryngeal cancer using high wavenumber Raman spectroscopy,” Biosens. Bioelectron. 35 (1), 213-217 (2012).
11. Aubertin et al., “Combining high wavenumber and fingerprint Raman spectroscopy for the detection of prostate cancer during radical prostatectomy”, 9, (9), Biomedical Optics Express, p. 4294, (2018)
12. R. Pandey et al, “Raman spectroscopy based molecular barcoding: realizing the value of high wavenumber region in breast cancer detection”, Proc. SPIE 11631, Advanced Biomedical and Clinical Diagnostic and Surgical Guidance Systems XIX, 1163105 (5 Mar. 2021).
13. Kho et al., “Hyperspectral Imaging for resection Margin Assessment during Cancer Surgery”, Clin Cancer Res; 25 (12), Jun. 15, 2019.
14. Gorpas et al., “Autofluorescence lifetime augmented reality as a means for real-time robotic surgery guidance in human patients”, Sci Rep 9, 1187 (2019).
15. U.S. Patent Publication No. 2023/0366821, “Multi-Spectral Imager for UV-Excited Tissue Autofluorescence Mapping, published Nov. 16, 2023.

1. A system for analyzing a tissue, comprising:
an excitation light unit configured to selectively produce a plurality of excitation lights, each said excitation light centered on a wavelength distinct from the centered wavelength of the other said excitation lights, wherein at least one of the excitation light centered wavelengths is configured to produce an autofluorescence emission from one or more biomolecules of interest present within the tissue, and a diffuse reflectance signal from the tissue;
a probe having a flexible cable and a probe head attached to a distal end of the flexible cable, wherein the flexible cable includes a plurality of light source optical fibers in communication with the excitation light unit to receive the plurality of excitation lights, and a light receiving conveyance structure configured to receive the autofluorescence emission, or the diffuse reflectance signal, or both, wherein the probe head is configured to receive the plurality of excitation lights from the plurality of light source optical fibers and produce a distribution of incident light oriented to exit a probe head exit aperture for application to the tissue;
at least one photodetector configured to detect the autofluorescence emission, or the diffuse reflectance signal, or both from the tissue as a result of the respective incident excitation light, and produce signals representative of the detected autofluorescence emission, or the detected diffuse reflectance signal, or both, wherein the at least one photodetector is in communication with the light receiving conveyance structure to receive the autofluorescence emission, or the diffuse reflectance signal, or both;
a system controller in communication with the excitation light unit, the at least one photodetector, and a non-transitory memory storing instructions, which instructions when executed cause the system controller to:
control the excitation light unit to sequentially produce the plurality of excitation lights;
receive and process the signals from the at least one photodetector for each sequential application of the plurality of excitation lights, and produce an image representative of the signals produced by each sequential application of the plurality of excitation lights; and
analyze the tissue using a plurality of the images to identify the presence of diseased tissue within the tissue.

2. The system of claim 1, wherein the excitation light unit includes a plurality of excitation light sources, each said excitation light source is configured to produce one of said excitation lights centered on said wavelength distinct from the respective centered wavelength of the other respective said excitation lights.

3. The system of claim 2, wherein the plurality of light source optical fibers and the light receiving conveyance structure are concentrically arranged.

4. The system of claim 3, wherein the plurality of light source optical fibers are disposed in a ring arrangement radially outside of the light receiving conveyance structure.

5. The system of claim 4, wherein the light receiving conveyance structure includes a plurality of optical fibers.

6. The system of claim 4, wherein the light receiving conveyance structure includes at least one relay lens.

7. The system of claim 1, wherein the probe head includes at least one Lambertian surface disposed to reflect the plurality of excitation lights from the plurality of light source optical fibers in a manner that produces the distribution of incident light oriented to exit the probe head through the probe head exit aperture for application to the tissue.

8. The system of claim 7, wherein the distribution of incident light oriented to exit the probe head through the probe head exit aperture for application to the tissue is substantially uniform.

9. The system of claim 8, wherein the distribution of incident light oriented to exit the probe head through the probe head exit aperture for application to the tissue is substantially uniform in angular and spatial orientation.

10. The system of claim 7, wherein the distribution of incident light oriented to exit the probe head through the probe head exit aperture for application to the tissue is randomized.

11. The system of claim 7, wherein the probe head includes an inner diffuser structure and an outer diffuser structure, both centered on a probe head central axis.

12. The system of claim 11, wherein the at least one Lambertian surface includes an inner diffuser Lambertian surface disposed relative to the plurality of light source optical fibers such that light exiting the plurality of light source optical fibers impinges upon the inner diffuser Lambertian surface for reflection within the probe head.

13. The system of claim 12, wherein the at least one Lambertian surface includes an outer diffuser Lambertian surface disposed radially outside of the inner diffuser Lambertian surface.

14. The system of claim 13, wherein the probe head is configured such that the distribution of incident light for application to the tissue exits the probe head exit aperture in a generally axial direction.

15. The system of claim 7, wherein the probe head includes an interior cavity, and the at least one Lambertian surface defines the interior cavity.

16. The system of claim 15, wherein the probe head is configured such that the distribution of incident light for application to the tissue exits the probe head exit aperture in a direction generally perpendicular to a central axis of the probe head.

17. The system of claim 16, wherein the probe head exit aperture is disposed parallel to the central axis of the probe head.

18. The system of claim 17, wherein the probe head includes an imaging window engaged with the probe head exit aperture.

19. The system of claim 7, wherein the probe head includes a prism configured to receive the autofluorescence emission, or the diffuse reflectance signal, or both from the tissue.

20. A method of analyzing a tissue, comprising:
producing a plurality of excitation lights, each excitation light centered on a wavelength distinct from the centered wavelength of the other excitation lights, wherein at least one of the excitation light centered wavelengths is configured to produce autofluorescence emissions from one or more biomolecules of interest, and a diffuse reflectance signals from the tissue;
using at least one Lambertian surface to randomize the plurality of excitation lights into a distribution of incident light that is substantially uniform in angular and spatial orientation and interrogating the tissue with the distribution of incident light;
using at least one photodetector to detect the autofluorescence emissions, or the diffuse reflectance signals, or both from the tissue, and to produce photodetector signals representative of the detected autofluorescence emissions, or the detected diffuse reflectance signals, or both;
processing the photodetector signals for each application of the distribution of incident light, including producing an image representative of the photodetector signals produced by each application of the distribution of incident light; and
analyzing the tissue using each image to identify the presence of diseased tissue within the tissue.
